(19) United States
(12) Patent Application Publication
(10) Pub. No.: US 2025/0076991 A1
(43) Pub. Date: Mar. 6, 2025

(54) ELECTRONIC DEVICE

(71) Applicant: ASUSTEK COMPUTER INC., Taipei (TW)

(72) Inventors: Sheng-Ta LIN, Taipei (TW); Tsung-Ju CHIANG, Taipei (TW)

(21) Appl. No.: 18/526,545

(22) Filed: Dec. 1, 2023

(30) Foreign Application Priority Data
Aug. 29, 2023 (TW) 112132628

(51) Int. Cl. G06F 3/02; G06F 1/16; G06F 3/0354; H01H 13/7065

(52) U.S. Cl. CPC G06F 3/0202; G06F 1/1662; G06F 1/169; G06F 3/03547; H01H 13/7065; H01H 2239/006

(57) ABSTRACT

The disclosure provides an electronic device. The electronic device includes a body, a touchpad, and a keyboard module. The body includes a surface, where the surface includes a first portion and a second portion that are adjacent to each other. The touchpad is arranged on the first portion. The keyboard module is arranged on the second portion and includes a first key. The first key includes a base plate, a circuit layer, a resilient structure, a key cap, and a conductor layer. The circuit layer is arranged on the base plate and configured to generate a first input signal. The resilient structure is arranged on the base plate. The key cap is arranged on the resilient structure. The conductor layer is arranged below the key cap and divided into a plurality of regions, where the regions are separated from each other and are configured to generate a plurality of second input signals.

### CROSS-REFERENCE TO RELATED APPLICATION

This application claims the priority benefit of Taiwan application serial No. 112132628, filed on Aug. 29, 2023. The entirety of the above-mentioned patent application is hereby incorporated by reference herein and made a part of the specification.

### BACKGROUND OF THE INVENTION

### Field of the Invention

The disclosure relates to an electronic device, and in particular, to an electronic device including a touchpad and a physical keyboard.

### Description of the Related Art

Conventional notebook computers are equipped with a touchpad and a keyboard as input apparatuses. Some notebook computers are further equipped with touchpad keys in the region above or below the touchpad to facilitate user operations.

The touchpad keys are designed as separate elements to provide a pressing effect. This design creates a split between the touchpad and the touchpad keys, affecting an outside of the notebook computer.

### BRIEF SUMMARY OF THE INVENTION

The disclosure provides an electronic device. The electronic device includes a body, a touchpad, and a keyboard module. The body includes a surface, where the surface includes a first portion and a second portion that are adjacent to each other. The touchpad is arranged on the first portion. The keyboard module is arranged on the second portion and includes a first key. The first key includes a base plate, a circuit layer, a resilient structure, a key cap, and a conductor layer. The circuit layer is arranged on the base plate and configured to generate a first input signal. The resilient structure is arranged on the base plate. The key cap is arranged on the resilient structure. The conductor layer is arranged below the key cap and divided into a plurality of regions, where the regions are separated from each other and are configured to generate a plurality of second input signals.

The electronic device in the disclosure is equipped with a conductor layer below the key cap of the first key of the keyboard module. The conductor layer is divided into the plurality of regions, and the regions sense a touch operation of a user to generate the plurality of second input signals. An arrangement of the conductor layer replaces conventional touchpad keys, preventing a split line between the touchpad keys and the touchpad from affecting an outside of the electronic device and preventing a dimension of the touchpad from being limited due to an arrangement of the touchpad keys.

### BRIEF DESCRIPTION OF THE DRAWINGS

FIG. 1 is a three-dimensional schematic diagram of an electronic device according to Embodiment 1 of the disclosure;

FIG. 2 is a block diagram of the electronic device in FIG. 1;

FIG. 3 is a schematic cross-sectional view of Embodiment 1 of a first key in FIG. 1;

FIG. 4 is a schematic cross-sectional view of Embodiment 2 of the first key in FIG. 1;

FIG. 5 is a schematic cross-sectional view of Embodiment 3 of the first key in FIG. 1;

FIG. 6 is a schematic cross-sectional view of Embodiment 4 of the first key in FIG. 1;

FIG. 7 is a three-dimensional schematic diagram of an electronic device according to Embodiment 2 of the disclosure;

FIG. 8 is a block diagram of the electronic device in FIG. 7;

FIG. 9 is a schematic diagram of an electronic device according to Embodiment 3 of the disclosure;

FIG. 10 is a schematic diagram of an electronic device according to Embodiment 4 of the disclosure; and

FIG. 11 is a three-dimensional schematic diagram of an electronic device according to Embodiment 5 of the disclosure.

### DETAILED DESCRIPTION OF THE EMBODIMENTS

Specific embodiments of the disclosure will be described in more detail below in combination with the accompanying drawings. The advantages and features of the disclosure become clearer based on the following descriptions and the appended claims. It should be noted that the drawings are in a very simplified form and a non-precise scale, and are only intended to explain the objective of embodiments of the disclosure in a convenient and clear way.

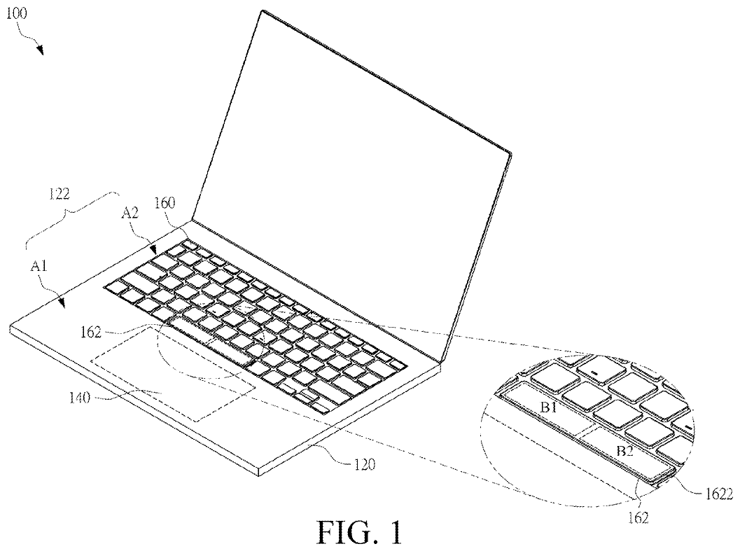

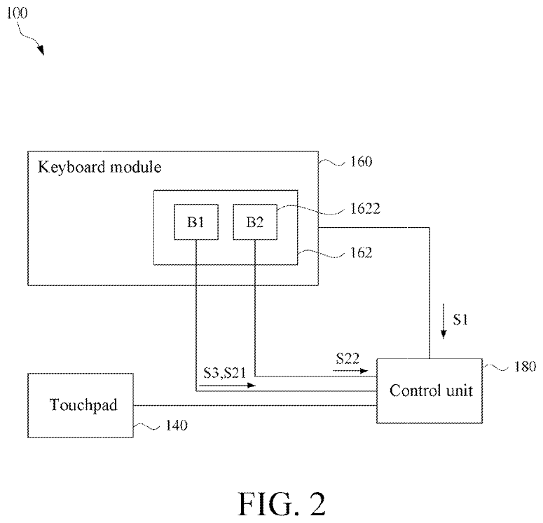

FIG. 1 is a three-dimensional schematic diagram of an electronic device according to Embodiment 1 of the disclosure. FIG. 2 is a block diagram of the electronic device 100 in FIG. 1. In an embodiment, the electronic device 100 is a notebook computer.

As shown in the figure, the electronic device 100 includes a body 120, a touchpad 140, and a keyboard module 160. The body 120 is a body of a host portion of the electronic device 100. The body 120 includes a surface 122, and the surface 122 includes a first portion A1 and a second portion A2 that are adjacent to each other. The touchpad 140 is arranged on the first portion A1. The keyboard module 160 is arranged on the second portion A2, and includes a first key 162. The touchpad 140 in this embodiment adopts a hidden design and is therefore presented by using a dashed line.

The first key 162 is located at a position close to the first portion A1 in the keyboard module 160, and is adjacent to the touchpad 140. The first key 162 is adapted to generate a first input signal S1 in response to a pressing behavior of a user. In an embodiment, the keyboard module 160 is a standard keyboard. The first key 162 is a space bar located at a middle position in the lowest row of the standard keyboard. The first input signal S1 is an input signal corresponding to the space bar.

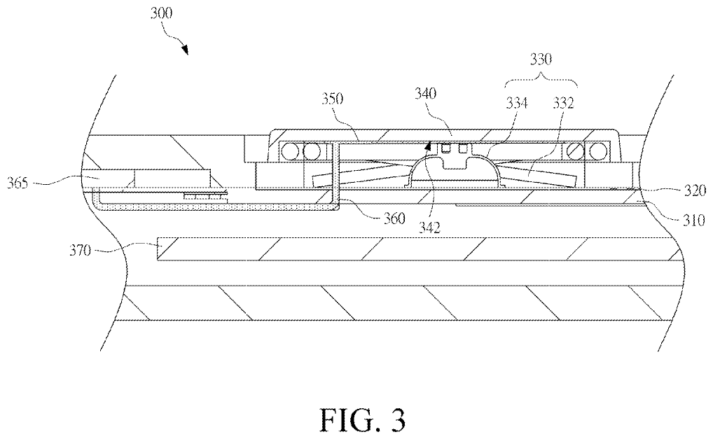

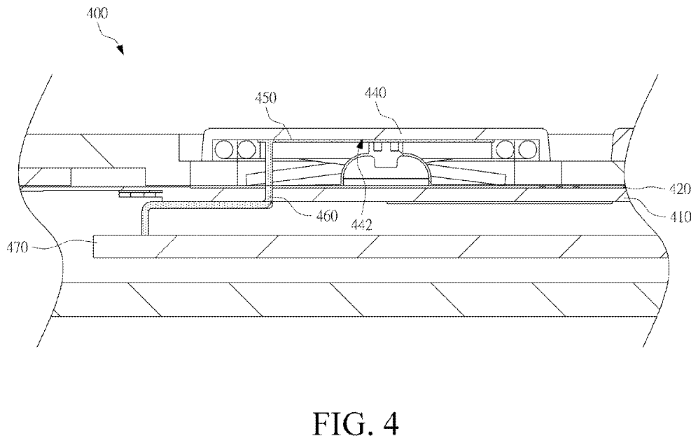

The first key 162 includes a conductor layer 1622. The conductor layer 1622 is hidden below a key cap of the first key 162, and is therefore presented by using a dashed line. The conductor layer 1622 is divided into two regions that are separated from each other in a long-side direction of the first key 162, that is, a left region B1 and a right region B2. There are more detailed descriptions in paragraphs corresponding to FIG. 3 and FIG. 4 for a specific structure of the first key 162.

The left region B1 and the right region B2 of the conductor layer 1622 detect a capacitance change generated by proximity of the user's finger by capacitive sensing, to generate two second input signals S21 and S22 corresponding to a left key and a right key of the touchpad 140. In this way, the user performs an operation corresponding to the left key and the right key of the touchpad 140 through the left region B1 and the right region B2. In an embodiment, the left region B1 and the right region B2 have same dimensions. In other embodiments, the left region B1 corresponding to the left key that is commonly used has a larger dimension.

The electronic device 100 in this embodiment also includes a control unit 180. The control unit 180 is electrically coupled to the first key 162 to receive the first input signal S1 from the first key 162 and the second input signals S21 and S22, and controls the first key 162 to switch operation to a key mode or a touchpad assistant mode according to a switching signal S3, to select to operate according to the first input signal S1 or according to the second input signals S21 and S22. In an embodiment, the control unit 180 is a main board of the electronic device 100.

In an embodiment, the switching signal S3 is a gesture signal generated by the conductor layer 1622. In an embodiment, the switching signal is a double-click signal corresponding to the left region B1 or the right region B2, or a signal generated corresponding to simultaneously clicking the left region B1 and the right region B2. The switching signal S3 generated by a gesture operation of the left region B1 is shown in the figure as an embodiment. In other embodiments, the switching signal S3 is a signal generated corresponding to simultaneously clicking the conductor layer 1622 and the touchpad 140.

When the first key 162 operates in the key mode, the control unit 180 executes a key function according to the first input signal S1, that is, the first key 162 is used to execute a function that is originally set in the keyboard module 160, such as data input. In an embodiment, if the first key 162 is a space bar, under execution of a file editing application program, the function is to enter a space.

When the first key 162 operates in the touchpad assistant mode, the control unit 180 executes a touchpad function according to the second input signals S21 and S22 corresponding to the left region B1 and the right region B2. In an embodiment, the control unit 180 executes a function corresponding to the left key and the right key of the touchpad 140 according to the second input signals S21 and S22 generated by the left region B1 and the right region B2 on the first key 162, to provide a function similar to a function of a mouse operation. In an embodiment, the control unit 180 sets the key mode as a preset mode.

Alternatively, in an embodiment, to facilitate the user to recognize a current operation mode of the first key 162, a light emitting diode is arranged in the first key 162 for illumination. When the first key 162 operates in the touchpad assistant mode, the first key 162 emits light to prompt the user.

Referring to FIG. 3, FIG. 3 is a schematic cross-sectional view of Embodiment 1 of a first key in FIG. 1. A cross-sectional direction in the figure is parallel to a short-side direction of the body 120 in FIG. 1.

As shown in the figure, a first key 300 includes a base plate 310, a circuit layer 320, a resilient structure 330, a key cap 340, and a conductor layer 350.

The circuit layer 320 is arranged on the base plate 310, and configured to generate the first input signal S1. The resilient structure 330 is arranged on the base plate 310. The key cap 340 is arranged on the resilient structure 330. The resilient structure 330 supports the key cap 340, and provides an elastic returning force to return the key cap 340 after the user presses the key cap 340. In an embodiment, the resilient structure 330 includes a scissor-mechanism 332 and an elastic member 334. The key cap 340 is arranged on a side of the scissor-mechanism 332 away from the base plate 310. The elastic member 334 is arranged directly below the key cap 340.

The conductor layer 350 is arranged on a lower surface 342 of the key cap 340. The conductor layer 350 detects a capacitance change generated by proximity of the user's finger by capacitive sensing, to generate the second input signals S21 and S22.

The second input signals S21 and S22 generated by the conductor layer 350 are transmitted to a touchpad 365 located on a side edge of the first key 300 through a conductive structure 360, and are transmitted to a main board 370 through the touchpad 365 for processing. In this embodiment, an existing signal transmission path between the touchpad 365 and the main board 370 is directly used to transmit the second input signals S21 and S22.

The first key 300 in this embodiment is a scissor-mechanism key. Other key structures including the key cap 340 and including a pressing stroke to provide a physical pressing effect is also applicable to the disclosure.

FIG. 4 is a schematic cross-sectional view of Embodiment 2 of the first key in FIG. 1.

A main difference between a first key 400 in this embodiment and the first key 300 shown in FIG. 3 lies in wiring manners of conductor layers 350 and 450.

Compared to the embodiment of FIG. 3 in which the second input signals S21 and S22 generated by the conductor layer 350 are transmitted outward through the touchpad 365, the second input signals S21 and S22 generated by the conductor layer 450 in this embodiment are directly transmitted to a main board 470 arranged below the first key 400 through a conductive structure 460 for processing. The conductive structure 460 extends from the conductor layer 450 on a lower surface 442 of a key cap 440 downward to a base plate 410, then penetrates the base plate 410, and extends downward to the main board 470.

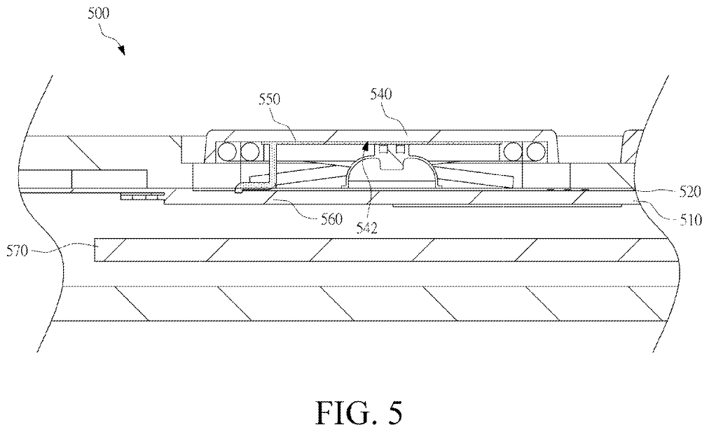

FIG. 5 is a schematic cross-sectional view of Embodiment 3 of the first key in FIG. 1.

A main difference between a first key 500 in this embodiment and the first key 300 shown in FIG. 3 lies in wiring manners of conductor layers 550 and 350.

Compared to the embodiment of FIG. 3 in which the second input signals S21 and S22 generated by the conductor layer 350 are transmitted outward through the touchpad 365, the second input signals S21 and S22 generated by the conductor layer 550 in this embodiment are transmitted to a circuit layer 520 on a base plate 510 of the first key 500 through a conductive structure 560, and transmitted to a main board 570 through the circuit layer 520 on the base plate 510 of the first key 500 for processing. The conductive structure 560 extends from the conductor layer 550 on a lower surface 542 of a key cap 540 downward to the circuit layer 520 on the base plate 510.

In this embodiment, an existing signal transmission path between the keyboard module in which first key 500 is located and the main board 570 is directly used to transmit the second input signals S21 and S22.

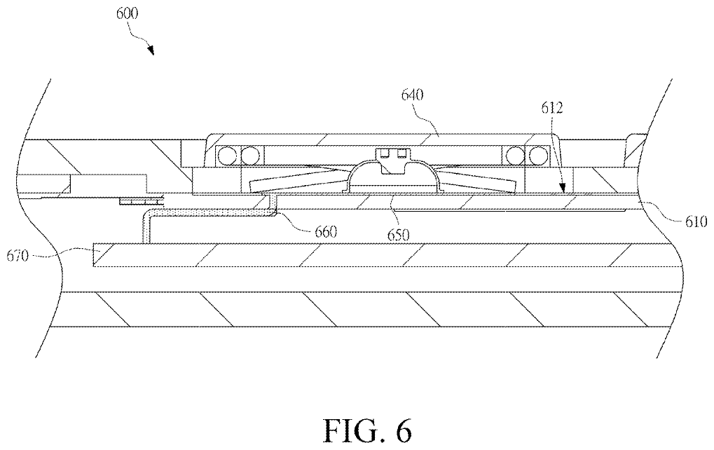

FIG. 6 is a schematic cross-sectional view of Embodiment 4 of the first key in FIG. 1.

A main difference between a first key 600 in this embodiment and the first key 300 shown in FIG. 3 lies in positions of conductor layers 350 and 650. Compared to the embodiment of FIG. 3 in which the conductor layer 350 is arranged on the lower surface 342 of the key cap 340, the conductor layer 650 in this embodiment is arranged on an upper surface 612 of a base plate 610. This embodiment is particularly applicable to a thin keyboard with a key cap 640 whose thickness is small.

In addition, because the conductor layer 650 in this embodiment is arranged on the upper surface 612 of the base plate 610, the second input signals S21 and S22 generated by the conductor layer 650 are directly transmitted to a main board 670 below the first key 600 through a conductive structure 660 that penetrates the base plate 610, to simplify a circuit design.

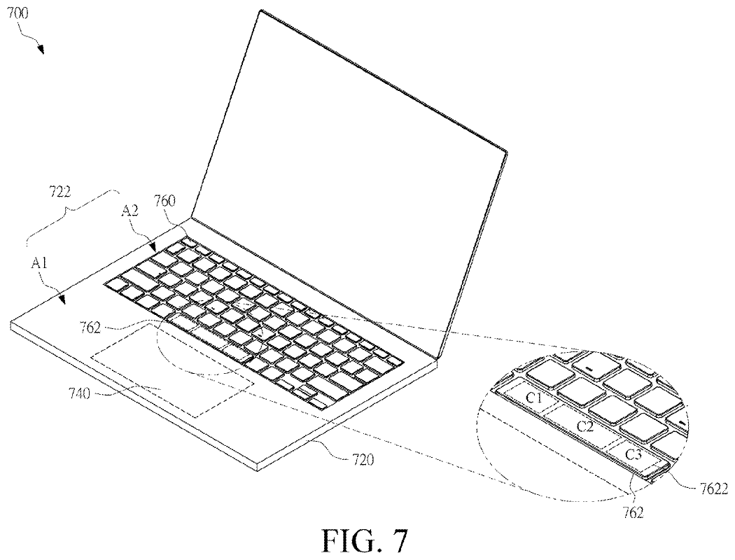

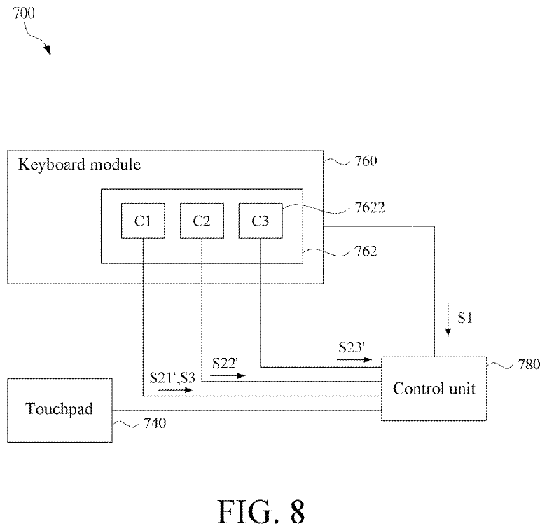

FIG. 7 is a three-dimensional schematic diagram of an electronic device 700 according to Embodiment 2 of the disclosure. FIG. 8 is a block diagram of the electronic device 700 in FIG. 7. In an embodiment, the electronic device 700 is a notebook computer.

Similar to the electronic device 100 shown in FIG. 1 and FIG. 2, the electronic device 700 in this embodiment includes a body 720, a touchpad 740, and a keyboard module 760. The body 720 includes a surface 722, where the surface 722 includes a first portion A1 and a second portion A2 that are adjacent to each other. The touchpad 740 is arranged on the first portion A1. The keyboard module 760 is arranged on the second portion A2 and includes a first key 762. The first key 762 includes a conductor layer 7622.

In the embodiment shown in FIG. 1, the conductor layer 1622 of the first key 162 is divided into two regions that are separated from each other, that is, the left region B1 and the right region B2, and are configured to generate the two corresponding second input signals S21 and S22. In contrast, in this embodiment, a conductor layer 7622 of the first key 762 is divided into three regions that are separated from each other in a long-side direction of the first key 762, that is, a left region C1, an intermediate region C2, and a right region C3. The left region C1, the intermediate region C2, and the right region C3 generate three corresponding second input signals S21′, S22′, and S23′.

The electronic device 700 in this embodiment also includes a control unit 780. The control unit 780 is electrically coupled to the first key 762 to receive the first input signal S1 from the first key 762 and the second input signals S21′, S22′, and S23′, and controls the first key 762 to switch operation to a key mode or a touchpad assistant mode according to a switching signal S3. In an embodiment, the control unit 780 is a main board.

In an embodiment, the switch S3 is a gesture signal generated by the conductor layer 7622, such as a double-click signal. The switching signal S3 generated by a gesture operation of the left region C1 is shown in the figure as an embodiment. The switching signal S3 is alternatively a signal generated by a gesture operation corresponding to the intermediate region C2 or the right region C3.

When the first key 762 operates in the key mode, the control unit 780 executes a key function according to the first input signal S1, that is, the first key 762 is used to execute a function that is originally set in the keyboard module 760, such as data input. In an embodiment, if the first key 762 is a space bar, under execution of a file editing application program, the function is to enter a space.

When the first key 762 operates in the touchpad assistant mode, the control unit 780 executes a touchpad function according to the second input signals S21′ and S23′ corresponding to the left region C1 and the right region C3, that is, the left region C1 and the right region C3 on the first key 762 are used as a left key and a right key of the touchpad 740, to provide a function similar to a mouse operation. In addition, the control unit 780 executes the key mode according to the second input signal S22′ corresponding to the intermediate region C2. That is, according to the second input signal S22′, a function that is originally set on the first key 762 by the keyboard module 760 is executed.

In other embodiments, the intermediate region C2 is alternatively used as a customized input key, and the user sets a key corresponding to the intermediate region C2. Specifically, the second input signal S22′ corresponding to the intermediate region C2 is set as a key corresponding to the space bar, the middle mouse button, or a user setting key. The user uses the switching signal S3 to cycle between the three modes of the space bar, the middle mouse button, and the user setting key.

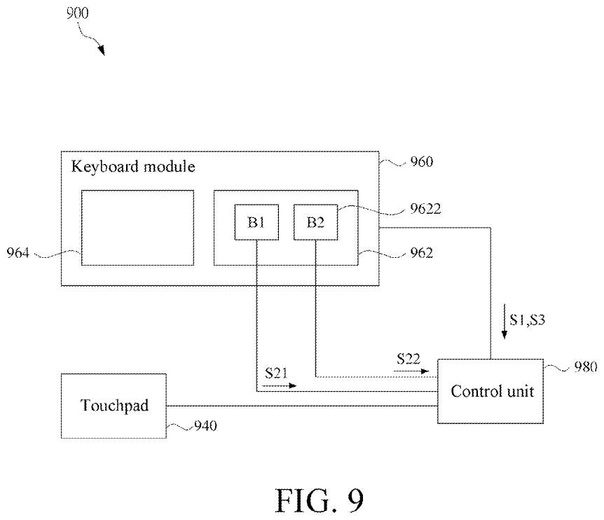

FIG. 9 is a schematic diagram of an electronic device 900 according to Embodiment 3 of the disclosure. A main difference between this embodiment and the embodiment of FIG. 2 lies in different sources of the switching signal S3.

In addition to a first key 962, a keyboard module 960 of the electronic device 900 in this embodiment further includes a second key 964. The second key 964 is different from the first key 962. In an embodiment, the second key 964 is a function key in the standard keyboard.

Compared to the embodiment of FIG. 2 in which the switching signal S3 is generated by the conductor layer 1622 of the first key 162, as shown in the figure, the switching signal S3 in this embodiment is generated through the second key 964 and provided to a control unit 980, instead of being generated by a conductor layer 9622 of the first key 962.

In addition, to avoid mode switching caused by the user mistakenly pressing the second key 964, in an embodiment, the switching signal S3 alternatively corresponds to the signal generated by simultaneously pressing the second key 964 and tapping the touchpad 940.

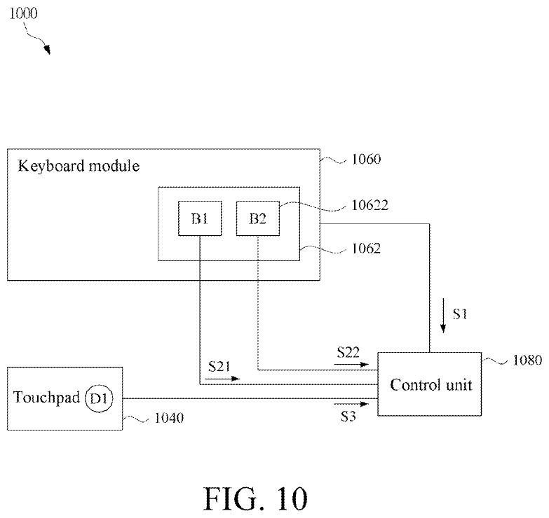

FIG. 10 is a schematic diagram of an electronic device 1000 according to Embodiment 4 of the disclosure. A main difference between this embodiment and the embodiment of FIG. 2 lies in different sources of the switching signal S3.

Compared to the embodiment of FIG. 2 in which the switching signal S3 is generated by the conductor layer 1622 of the first key 162, the switching signal S3 in this embodiment is generated by a touchpad 1040, instead of being generated by a conductor layer 10622 of a first key 1062.

Specifically, the switching signal S3 corresponds to a contact area DI detected by the touchpad 1040. When the contact area DI detected by the touchpad 1040 is less than a preset value, in an embodiment, when the contact area is zero, the touchpad 1040 generates the switching signal S3.

When a control unit 1080 detects the switching signal S3, and the first key 1062 of a keyboard module 1060 is in the touchpad assistant mode, the control unit 1080 controls the first key 1062 to switch operation to the key mode. In addition, when the control unit 1080 detects the switching signal S3, but the first key 1062 is already in the key mode, the control unit 1080 maintains the original key mode, instead of switching to the touchpad assistant mode.

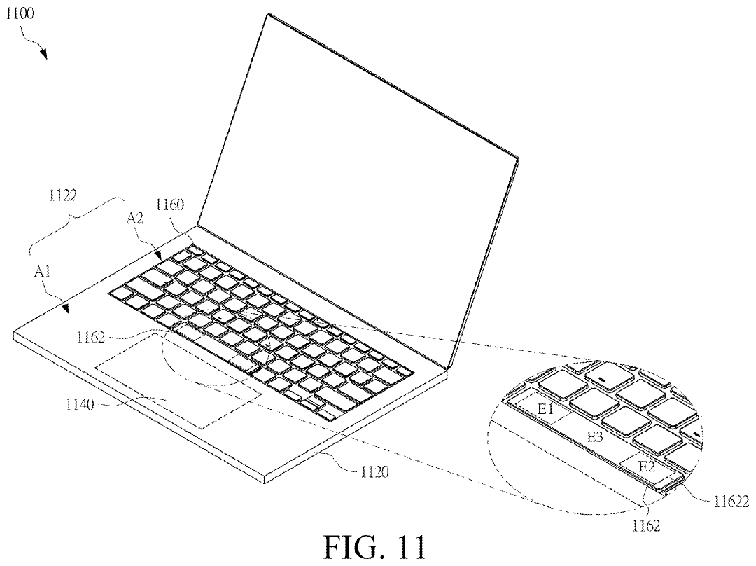

FIG. 11 is a three-dimensional schematic diagram of an electronic device 1100 according to Embodiment 5 of the disclosure. In an embodiment, the electronic device 1100 is a notebook computer.

Similar to the electronic device 100 shown in FIG. 1, the electronic device 1100 in this embodiment includes a body 1120, a touchpad 1140, and a keyboard module 1160. The body 1120 includes a surface 1122, where the surface 1122 includes a first portion A1 and a second portion A2 that are adjacent to each other. The touchpad 1140 is arranged on the first portion A1. The keyboard module 1160 is arranged on the second portion A2 and includes a first key 1162. The first key 1162 includes a conductor layer 11622.

In the embodiment shown in FIG. 1, the conductor layer 1622 of the first key 162 is divided into two regions that are separated from each other, that is, the left region B1 and the right region B2, and the left region B1 is adjacent to the right region B2.

In contrast, the conductor layer 11622 of the first key 1162 in this embodiment is also divided into a left region E1 and a right region E2 that are separated from each other. However, there is a blank region E3 between the left region E1 and the right region E2 for the user to directly press the first key 1162. In this way, even if the first key 1162 is switched to operating in the touchpad assistant mode, the user presses the blank region E3 of the first key 1162 to execute an original function of the first key 1162, and does not need to switch the first key 1162 back to the key mode.

The electronic devices 100, 700, 900, 1000, and 1100 are equipped with the conductor layers 1622, 350, 450, 550, 650, 7622, 9622, 10622, and 11622 below the key caps of the first keys 162, 300, 400, 500, 600, 762, 962, 1062, and 1162 of the keyboard modules 160, 760, 960, 1060, and 1160. The conductor layers 1622, 350, 450, 550, 650, 7622, 9622, 10622, and 11622 are divided into the plurality of regions. The regions sense the touch operation of the user to generate the plurality of second input signals S21, S22, S21′, S22′, and S23′. Arrangements of the conductor layers 1622, 350, 450, 550, 650, 7622, 9622, 10622, and 11622 replace the conventional touchpad keys, preventing a split line between the touchpad keys and the touchpads 140, 365, 740, 940, 1040, and 1140 from affecting an outside of the electronic devices 100, 700, 900, 1000, and 1100 and preventing dimensions of the touchpads 140, 365, 740, 940, 1040, and 1140 from being limited due to an arrangement of the touchpad keys.

The above are only preferred embodiments of the disclosure, and do not constitute any limitation on the disclosure. Any person skilled in the art making any form of equivalent replacement or modification to the technical means and technical content disclosed in the disclosure, within the scope of the technical means of the disclosure, does not deviate from the content of the technical means of the disclosure, and still falls within the scope of protection of the disclosure.

What is claimed is:

1. An electronic device, comprising:
a body, comprising a surface, wherein the surface comprises a first portion and a second portion that are adjacent to each other;
a touchpad, arranged on the first portion; and
a keyboard module, arranged on the second portion and comprising a first key, wherein the first key comprises:
a base plate;
a circuit layer, arranged on the base plate and configured to generate a first input signal;
a resilient structure, arranged on the base plate;
a key cap, arranged on the resilient structure; and
a conductor layer, arranged below the key cap and divided into a plurality of regions, wherein the regions are separated from each other and are configured to generate a plurality of second input signals.

2. The electronic device according to claim 1, wherein the first key is adjacent to the first portion.

3. The electronic device according to claim 1, wherein the conductor layer is divided into the regions in a long-side direction of the first key.

4. The electronic device according to claim 3, wherein the regions comprise a left region and a right region.

5. The electronic device according to claim 4, wherein the left region and the right region have same dimensions.

6. The electronic device according to claim 3, wherein the regions comprise a left region, a right region, and an intermediate region.

7. The electronic device according to claim 1, wherein the conductor layer is located on a lower surface of the key cap.

8. The electronic device according to claim 1, wherein the conductor layer is located on an upper surface of the base plate.

9. The electronic device according to claim 1, further comprising a control unit, electrically coupled to the first key, and configured to control, according to a switching signal, the first key to operate in a key mode or a touchpad assistant mode.

10. The electronic device according to claim 9, wherein the switching signal is generated by the conductor layer.

11. The electronic device according to claim 10, wherein the switching signal is a double-click signal.

12. The electronic device according to claim 9, wherein the regions comprise a left region and a right region, and when the first key operates in the key mode, the control unit executes a key function according to the first input signal, and when the first key operates in the touchpad assistant mode, the control unit executes a touchpad function according to the second input signals corresponding to the left region and the right region.

13. The electronic device according to claim 9, wherein the regions comprise a left region, a right region, and an intermediate region, and when the first key operates in the key mode, the control unit executes a key function according to the first input signal, and when the first key operates in the touchpad assistant mode, the control unit executes a touchpad function according to the second input signals corresponding to the left region and the right region, and executes the key function according to the second input signal corresponding to the intermediate region.

14. The electronic device according to claim 9, wherein the switching signal is generated by the keyboard module.

15. The electronic device according to claim 14, wherein the keyboard module comprises a second key, the second key is different from the first key, and the switching signal is generated by the second key.

16. The electronic device according to claim 9, wherein the switching signal is generated by the touchpad.

17. The electronic device according to claim 16, wherein the switching signal corresponds to a contact area of the touchpad, and when the contact area is less than a preset value, the control unit controls the first key to operate in the key mode.

18. The electronic device according to claim 1, wherein the first key is a space bar.
